(19) United States
(12) Patent Application Publication
(10) Pub. No.: US 2015/0378381 A1
(43) Pub. Date: Dec. 31, 2015

(54) SYSTEMS AND METHODS FOR ENERGY COST OPTIMIZATION

(71) Applicant: QUALCOMM Incorporated, San Diego, CA (US)

(72) Inventors: Peerapol Tinnakornsrisuphap, San Diego, CA (US); Shengbo Chen, San Diego, CA (US); Rashid Ahmed Akbar Attar, San Diego, CA (US)

(21) Appl. No.: 14/320,631

(22) Filed: Jun. 30, 2014

(51) Int. Cl. G05F 1/66; G05B 15/02; F24F 11/00

(52) U.S. Cl. CPC G05F 1/66; F24F 11/0009; G05B 15/02

(57) ABSTRACT

Energy-related devices such as heating, ventilation, and air conditioning (HVAC) units, electric vehicle charging platforms, and solar panels are becoming increasingly networkable within a home or business environment. Furthermore, utility providers are offering flexible pricing schemes that adjust the cost of energy over time based on overall demand, and the energy pricing data is made publically available. Provided are exemplary techniques that utilize this pricing data as well as exploit various synergies between the networked energy-related devices to develop automated and cost-effective energy control solutions.

### BACKGROUND

1. Technical Field

The present application generally relates to smart energy management and, more specifically, to systems and methods of optimizing energy cost associated with a home or other facility with networked energy-related devices.

2. Related Art

Home energy consumption is a significant portion of consumer expenses or expenses for small enterprises. As such, dealing with expense has spurred innovation and various industry trends. For example, consumers are increasingly able to supplement energy from utility providers with sources directly associated with their homes, such as solar panels, wind generators, and micro combined heating and power (CHP) units. Furthermore, the energy storage capacity of the average household is increasing due to factors such as discrete backup power systems and batteries of electric vehicles connected to homes.

Currently, programmable thermostat systems such as the Nest® Learning Thermostat by Nest Labs allow users to view details about their current energy consumption. These systems can further “learn” user preferences over time, such that the users' previous selections are used to predict a user's home environment selections.

Recent advancements have also allowed for electrical utility companies to provide real-time and projected energy pricing, and this energy pricing data can be made available to consumers. As the pricing data can fluctuate throughout the course of a day (or week, month, etc.), however, consumers can find it time-consuming, if not overwhelming, to manually modify their home energy usage based on the constantly changing energy pricing data.

### SUMMARY

Disclosed herein are systems and methods for centralized home energy control that provide optimized cost and comfort, taking advantage of various synergies that can be exploited between the various networked devices and entities of an advanced home or small business power system. The disclosed systems and methods may include a smart energy controller that may be connected to or collocated with one or more local energy sources, energy reserves, and loads associated with a home or other facility. The smart energy controller may analyze past and current energy usage and generation to predict future usage and generation with a high level of granularity.

The smart energy controller may further communicate with external servers to receive energy pricing data and other information that is relevant to energy pricing and consumption, such as outside temperature and solar forecasts. This data is used to generate pricing models and projected consumption. Alternatively or additionally, the smart energy controller may generate pricing models using information stored locally. Through pricing models and the analysis of energy usage and generation, the smart energy controller may adaptively control the local energy sources, energy reserves, and loads to optimize the total energy cost associated with the home. In general, energy cost savings are realized by optimizing the times at which energy is used, stored, and generated. This can occur even while maintaining the same level of total energy consumption over a certain time period.

The cost-optimizations can be realized over a wide variety of subsystems and loads. For example, electric vehicles generally need to be charged each day to receive a certain amount of energy. The smart energy controller can determine this amount of energy, be it through predictive measures based on historical trends or through direct communication with the electric vehicle, and further utilizes projected energy pricing information to select cost-optimal times (e.g., times of the day/night when the marginal cost of energy is least expensive) for charging the vehicle over each cycle (e.g., time between each trip). A “water-filling” algorithm can be used to determine the time periods of lowest cost, followed by incrementally higher-cost periods. This process is repeated until there is a complete plan for receiving and storing, within the vehicle's battery, the total charge required for that cycle.

This process can further involve setting a price threshold that specifies a maximum price for the marginal increases in energy consumption. Through this process, the home may, in some cases, consume or store the same amount of energy with a lower overall cost to the consumer. Further, the energy consumption may be coordinated with the consumer-provided energy sources to further reduce costs. Further, the optimization may occur at the household level without excessive or unnecessary control from the utility providers. The techniques described with respect to this process can be applicable to other types of loads having similar characteristics, and not just electric vehicles, e.g., any type of energy-consuming instrument or other device that is periodically removed from the home power system (power tools, garden instruments, lawn tractors, etc.).

Some types of loads, such as pool pumps, periodically require a continuous time interval of power for proper operation. However, the specific start time can be varied, and this provides a degree of freedom. Using the pricing models and known requirements (e.g., operational deadlines or frequency), the smart energy controller may select cost-optimal time periods to provide energy to these loads. Essentially, the optimal start times may be calculated and potentially varied each cycle to provide the lowest overall cost.

In some embodiments, the smart energy controller may control a home's heating, ventilation, and air conditioning (HVAC) unit. The smart energy controller may receive and store pricing data, other external data (e.g., weather/solar/cloud information), and user preferences (e.g., schedule and min/max temperature). The smart energy controller may further generate a thermal model of the home, which determines how well the home can retain heat. Using this information, the smart energy controller can preheat the home to above a minimum bound (e.g., a typical set-point) but within a maximum bound, if the preheating is predicted to reduce cost. For example, a home could be preheated during a period of low energy cost (e.g., 4 PM, before the consumer returns home), so that less energy is required to maintain the temperature within user-set bounds during a time when the energy cost is higher (e.g., 6 PM). This technique exploits the thermal capacitance of a home, allowing energy to be purchased and stored (e.g., as heat) when it is least expensive. A similar “precool” strategy can be implemented.

Similar techniques could be employed with other home energy storage systems, such as flywheels and thermal batteries, i.e., using dynamic pricing information to “charge” energy into such systems when power is relatively inexpensive and loading on the home energy system within the home is otherwise low and reclaiming energy from such systems when power is expensive and there are otherwise particularly higher energy needs in the home energy system.

### BRIEF DESCRIPTION OF THE DRAWINGS

Features, aspects, and embodiments of the disclosure are described in conjunction with the attached drawings, in which:

FIG. 1 shows an architectural overview of an energy ecosystem, upon which the principles of the present disclosure may be applied;

FIG. 2 shows a block diagram illustrating a local electrical system having a plurality of interconnected energy-related devices;

FIG. 3 shows a thermal model of a home with various sources affecting the temperature inside the home;

FIG. 4 shows a graph illustrating energy prices over the course of a day;

FIG. 5 shows a graph illustrating exemplary temperature thresholds in a home;

FIGS. 6A-6B show graphs illustrating an exemplary preheating technique based, in part, on pricing data, in accordance with the disclosed principles;

FIG. 7 shows a flowchart diagram illustrating an exemplary process for heating and cooling a home;

FIG. 8 shows a block diagram illustrating a system for charging an electric vehicle;

FIG. 9 shows a graph illustrating a strategy for charging an electric vehicle's battery using a water-filling algorithm; and

FIG. 10 shows a flowchart diagram illustrating an exemplary process for charging an electric vehicle.

These exemplary figures and embodiments are to provide a written, detailed description of the subject matter set forth by any claims that issue from the present application. These exemplary figures and embodiments should not be used to limit the scope of any claims.

Further, although similar reference numbers may be used to refer to similar structures for convenience, it can be appreciated that each of the various example embodiments may be considered to be distinct variations.

### DETAILED DESCRIPTION

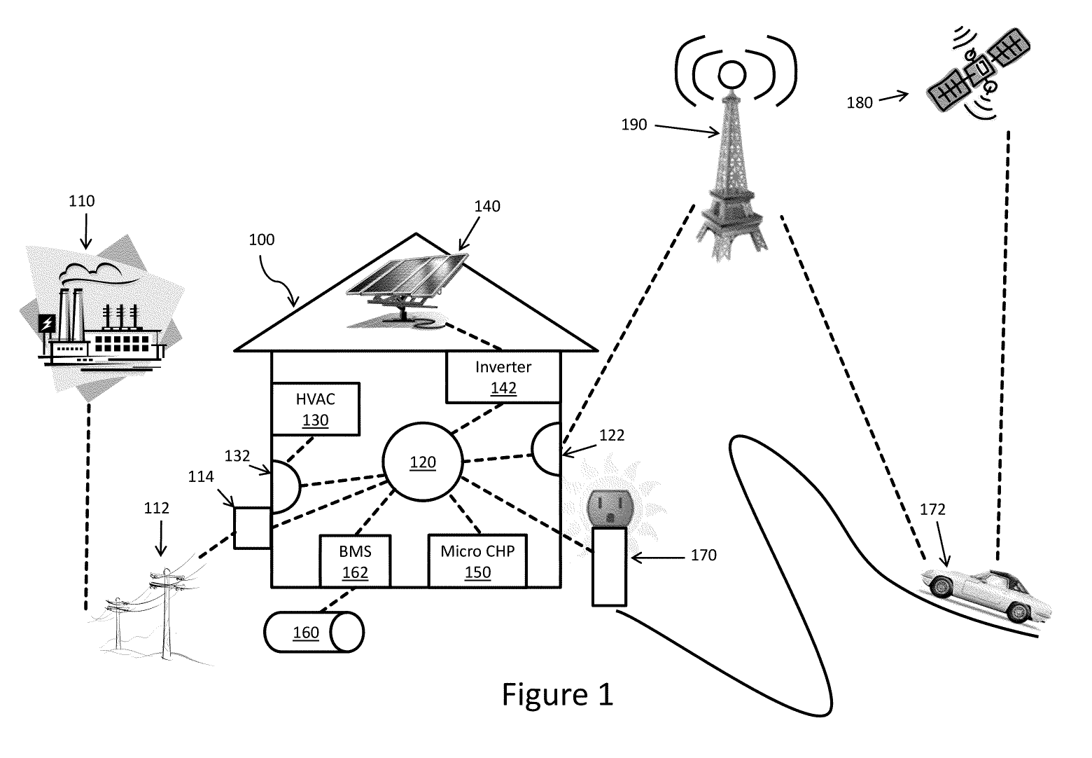

FIG. 1 shows an architectural overview of an energy “ecosystem,” upon which the principles of the present disclosure may be applied. The figure includes various energy sources, energy reserves, and loads that are located within or closely associated with a “local” home energy system 100. The figure also includes various “external” elements such as loads that can be disconnected from the home energy system 100, communications elements, and data sources. Certain entities or elements discussed in the present application may not be included in the present figures for clarity.

As shown in FIG. 1, a user's home energy system 100 may be connected to a utility provider 110 (e.g., a power plant) via a power grid 112. The home energy system 100 may both receive and transmit electrical power to the grid 112, with the exchange monitored by a smart meter 114. The home may include a smart energy controller 120, which may act as a centralized controller for the various energy-related devices associated with the home energy system 100.

The dashed lines in FIG. 1 represent connections between various entities within the energy ecosystem. These connections may provide power, channels of communication, or both between the connected entities. These channels may be unidirectional or bi-directional. In some embodiments, only a subset of these channels may be available and active. Devices (e.g., local energy sources, energy reserves, and loads) associated with the home energy system 100 may each convey operational state information to the smart energy controller 120. The devices may also receive control instructions from the smart energy controller 120 that may, at least in part, determine the devices' operational states.

The home energy system 100 may include a heating, ventilation, and air conditioning (HVAC) unit 130 as a load, and the HVAC unit 130 may provide climate control within the home. The HVAC unit 130 may be controlled by a smart thermostat 132, which may set and monitor the operational state of the HVAC unit 130. The smart thermostat 132 may receive instructions from the smart energy controller 120 so that the HVAC unit 130 may be coordinated with other devices associated with the home, and so that additional factors (e.g., pricing information) may be taken into account, as will be discussed later.

The home energy system 100 may supplement energy received from the grid 112 with locally generated energy from local energy sources. In the embodiment shown in FIG. 1, the home energy system 100 is connected to two exemplary local energy sources: a solar panel 140 and a micro combined heating and power (CHP) unit 150. The solar panel 140 may be controlled via a solar inverter 142. The solar inverter 142 may implement maximum power point tracking and/or other techniques known in the art to improve utilization of the solar panel 140. The solar inverter 142 may report an instantaneous energy generation rate and other parameters associated with the operational state of the solar panel 140 to the smart energy controller 120. In some embodiments, the solar inverter 142 may receive control instructions from the smart energy controller 120.

The micro CHP unit 150 may utilize fuel from a fuel source (not shown) to generate power while simultaneously generating useful (e.g., recoverable) heat for the home, through a technique known as cogeneration. Micro CHP units are become increasingly common due, in part, to their high levels of efficiency in conjunction with the rising cost of utility power. The micro CHP unit 150 may similarly report an instantaneous energy generation rate and other parameters (such as the level of stored heat and/or water temperature) to the smart energy controller 120. In embodiments where the micro CHP unit 150 is not connected to natural gas lines and instead utilizes fuel reserves, the micro CHP unit 150 may further report an amount of fuel remaining to the smart energy controller 120. The smart energy controller 120 may change the operational state of the micro CHP unit 150 based on the needs of the overall system. For example, the micro CHP unit 150 may be activated when the price of energy from the grid is relatively high (e.g., above a price threshold). The price threshold may be determined by a variety of factors such as the amount of wasted heat, the price of fuel, the efficiency of the micro CHP unit 150, user input, or any combination thereof. As the micro CHP unit 150 also generates heat, its operational state may also depend on current or future heating requirements of the home.

The home energy system 100 may further include one or more local energy reserves such as a battery 160 for locally storing energy. The battery 160 may be coupled with a battery management system (BMS) 162, which may monitor, charge, and discharge the battery 160. The battery management system 162 may report an amount of charge (sometimes referred to as a State of Charge) stored in the battery 160 as well as an instantaneous charging or discharging rate to the smart energy controller 120.

Local energy reserves, such as the battery 160, allow the home to store excess energy that may be either received from the grid 112 or generated by local energy sources. The local energy reserves provided by the battery 160 generally provide increased flexibility for coordinating energy consumption over a period of time. For example, the local energy reserves can accumulate energy during periods of low demand and, as a result, low marginal cost (e.g., late at night and early in the morning), in preparation for consumption during a later period projected to have a higher marginal cost (e.g., evenings). Furthermore, local energy reserves can also attenuate spikes in the net energy demanded by loads associated with the home energy system 100 (e.g., when numerous loads are simultaneously active). In that sense, local energy reserves act as a low-pass filter to smooth home energy demand, which in addition to reducing overall costs to the consumer can provide significant benefits for the grid 112 and the utility providers 110.

In energy delivery systems where homes may return power to the grid 112, local energy reserves may better enable the home energy system 100 to return power during peak demand periods. Utility providers 110 may in turn compensate the home owner through reductions in their energy bill.

The home energy system 100 may also provide power to a local charging platform 170 (e.g., electric vehicle supply equipment) for charging electric vehicles 172. The charging platform 170 may communicate with the smart energy controller 120 to send operational state information regarding an associated electric vehicle 172. The operational state information may include a charge level within the electric vehicle's battery, an instantaneous charging rate, and/or a tentative charging schedule. The charging platform 170 may also receive control instructions from the smart energy controller, which may include setting the instantaneous charging rate, the tentative charging schedule, or simply a deadline for reaching a desired level of charge.

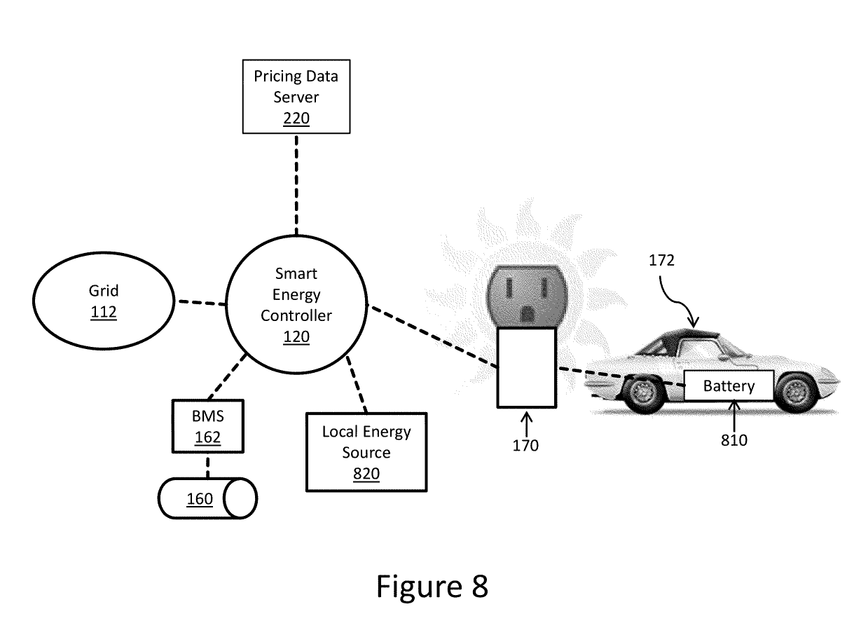

The battery of the electric vehicle 172 may serve as a local energy reserve when the electric vehicle 172 is parked at the home. In some embodiments, the battery of the electric vehicle 172 may be discharged to provide power back to the home energy system 100 through the charging platform 170. However, even in embodiments where the charging platform 170 does not provide power back to the home energy system 100, the battery of the electric vehicle 172 can provide scheduling flexibility due to its electrical capacitance. For example, the smart energy controller 120 may vary the charging times of the electric vehicle's battery in order to optimize (e.g., reduce) the total cost of energy in the system. This optimization may occur by charging the battery during periods when the marginal cost of receiving electricity from the grid 112 is relatively low. FIGS. 8-10 describe a cost optimization technique for charging an electric vehicle's battery in greater detail.

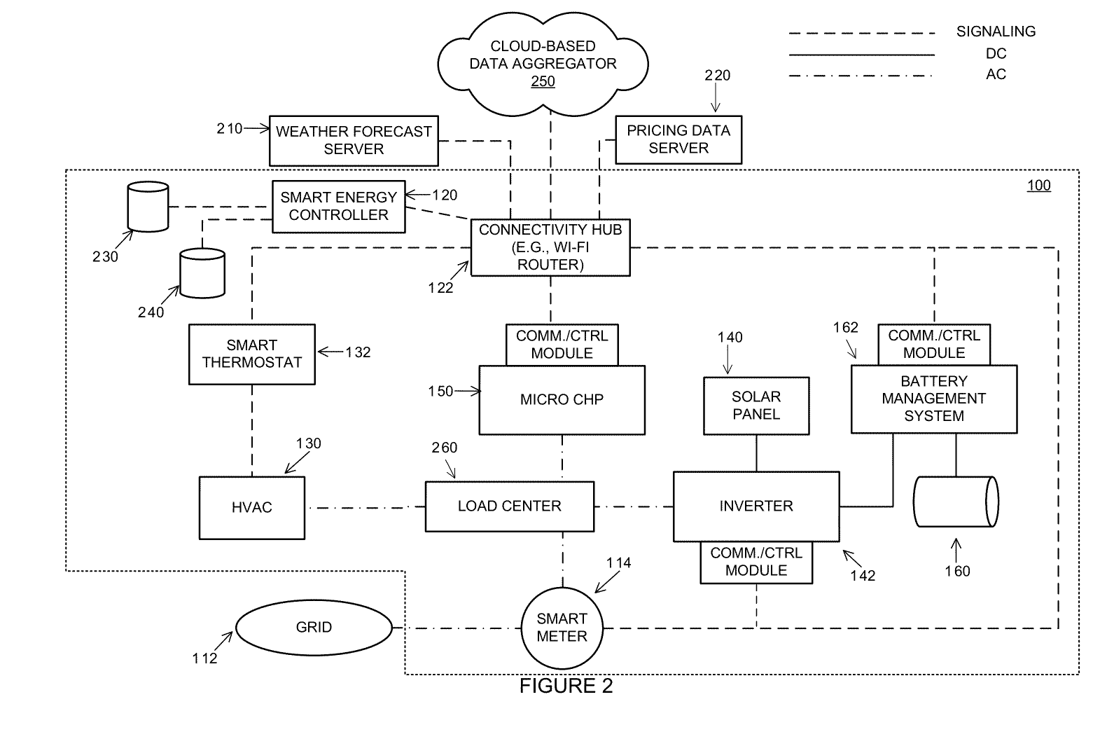

When determining optimal charging schedules for the electric vehicle 172, the system may utilize location information associated with the electric vehicle 172 and/or the user to help determine a user schedule as well as the charge required for each cycle, where a cycle may represent time between consecutive trips away from the home. The location information may be obtained through any of a variety of technologies, such as Global Positioning System (GPS) technology. In the embodiment shown in FIG. 1, the electric vehicle 172 has a GPS unit which may be connected to a plurality of GPS satellites 180. In some embodiments, the GPS unit on the electric vehicle 172 is replaced or supplemented with a GPS unit on a user's mobile device. The GPS unit within the electric vehicle 172 and/or the user's mobile device generates location information which may be received by the smart energy controller 120. Cellular networks provide one method to achieve this transmission. The GPS unit may transmit the location information to the cellular network through a base station 190. The cellular network may then deliver the location information to a connectivity hub 122 (e.g., Wi-Fi router) associated with the home. The connectivity hub 122 may then receive this information from the cellular network and relay it to the smart energy controller 120. Further, the connectivity hub 122 may provide additional information to the smart energy controller 120, as will be discussed in FIG. 2 and the accompanying description.

Referring back to FIG. 1, while the cellular network is represented by a single base station 190 for clarity, numerous intermediate communicational entities may exist between the GPS unit and the smart energy controller 120. In some embodiments, the location information is sent to the smart energy controller 120 using, for at least a portion of the transmission, an internet protocol. Various other techniques known in the art may be used to send the location information of the electric vehicle 172 to the smart energy controller 120.

The smart energy controller 120 may log and analyze the location information to determine the current and past usage of the electric vehicle. Alternatively or additionally, the location information may be analyzed by a GPS unit or another device outside of the home energy system 100 to synthesize a user schedule and/or vehicle usage information. The synthesized information may then be received by the smart energy controller 120.

Using the synthesized information and/or unsynthesized location information, the smart energy controller 120 may predict the amount of mileage and charge required for the electric vehicle 172 in future cycles. The smart energy controller 120 may also predict the times at which the user arrives and leaves the home. The location information may also be used for thermostat and HVAC control, e.g., by adjusting the thermostat to precool the home when the user starts or is on the way home. The user may be allowed to manually change any of these predictions through a user interface in communication with the home energy system 100, including through a user's mobile device. These predictions are further discussed in the description of FIG. 8.

While a single home energy system 100 and utility provider 110 are shown in FIG. 1, the architecture may include a plurality of homes and/or a plurality of utility providers. Furthermore, each home energy system 100 may use a plurality of any of the devices connected to the smart energy controller 120. For example, in some embodiments, the home energy system 100 may be connected to a plurality of charging platforms 170, and each charging platform 170 may in turn service one or more electric vehicles 172. Further, while a user is often described in the singular form, it is to be understood that the disclosed principles in FIG. 1 and throughout the application also apply to home energy systems 100 having more than one user (e.g., home occupant).

FIG. 2 shows a block diagram illustrating a home energy system 100 having a plurality of interconnected energy-related devices. The home energy system 100 (e.g., local electrical system 100) may be implemented within a home to optimize (e.g., reduce) the cost of energy consumption from loads and subsystems associated with the home. FIG. 2 contains certain entities that may be similar or identical to those present in FIG. 1. These entities are labeled with the same reference numerals and will not be described again.

As shown in FIG. 2, the smart energy controller 120 may be in communication with a connectivity hub 122 (introduced in FIG. 1, above). In some embodiments, the connectivity hub 122 may be implemented as a home router having Wi-Fi capability. The connectivity hub 122 may allow the smart energy controller 120 to communicate with the various loads, energy reserves, and energy sources within the local electrical system 100. The connectivity hub 122 may further allow the smart energy controller 120 to communicate with external servers. These servers may include weather forecast servers 210, pricing data servers 220, and other external servers.

The weather forecast server 210 may provide the smart energy controller 120 with access to current and predicted weather trends that may affect home energy consumption. This may include data associated with cloud cover and solar patterns, which may be used to predict the amount of energy that will be generated by the solar panel 140. The weather forecast server 210 may also provide temperature data which may be used to determine past, current, and future demand on the HVAC unit 130 and/or the micro CHP unit 150.

The smart energy controller 120 may communicate with a non-volatile memory device 230 that stores machine-readable instructions for the smart energy controller 120. The smart energy controller 120 may execute the stored instructions to perform the tasks and functionalities described explicitly or implicitly herein. The smart energy controller 120 may further communicate with a configuration database 240 which may store variables related to a user and/or a home. The variables may include profile information for the user, such as temperature preferences and an occupancy schedule. The occupancy schedule may include both historic data and future predictions, which may be modified by the user. The configuration database 240 may also store parameters associated with a thermal model for the home. The configuration database 240 may be periodically updated as the thermal characteristics of the home may change over time. Such variation naturally occurs over the lifecycle of a home as various physical aspects change (e.g., insulation deteriorates or is replaced). Various other configuration parameters and the like may also be stored in the configuration database 240

While FIG. 2 shows a single configuration database 240, a plurality of configuration databases 240 may be used. For example, in some embodiments, user schedule data may be stored in a different database than what is used for storing the thermal characteristics of the home.

The smart energy controller 120 may send any of the stored parameters and other collected information to a cloud-based data aggregator 250. The aggregation of data collected from multiple homes can serve a powerful function of determining and predicting macro-level trends. Synthesized data or instructions may then be sent back to the smart energy controllers 120 within individual homes. Precautions may be taken to coordinate various homes so they do not react simultaneously to commonly received data or in a manner as to place stress on or overload the grid 112. A randomization technique may be implemented at the cloud-based data aggregator 250 to prevent such occurrences. For example, data may be reported to individual homes with randomized delay, which may promote the resulting individual reactions to be distributed over time. Alternatively, a systematic (e.g., not randomized) approach may be taken to allow the reactions to be distributed over time.

As described above, the smart meter 114 may monitor the energy transferred between the grid 112 and the local electrical system 100. The load center 260 (oftentimes referred to as a circuit breaker panel or fuse box) may serve as the next point of contact before power is distributed among the various loads and energy reserves. The load center 260 provides easy access for manually activating and deactivating individual loads and subsystems. The load center 260 may receive alternating current (AC) power from the grid 112 through the smart meter 114 and may distribute this power to various loads such as the HVAC unit 130. The load center 260 may also receive AC power from local energy sources such as the micro CHP unit 150 and the solar inverter 142. In some embodiments direct current (DC) power is used to transfer energy between two or more entities within the system. The power, whether it is AC or DC, may be monitored with current sensors (e.g., current shunts and associated sense circuitry) in communication with the smart energy controller 120.

To maximize connectivity within the local electrical system 100, the loads, energy sources, and energy reserves may include communication and control modules to enable communication with the smart energy controller 120. In the embodiment shown in FIG. 2, the micro CHP unit 150, the solar inverter 142, and the battery management system 162 may each have such modules as illustrated to both receive instructions and send telemetry data to the smart energy controller 120 through the connectivity hub 122. The smart thermostat 132 and the smart meter 114 may similarly be operable to communicate through the connectivity hub 122. Communication may entail using established protocols to maximize compatibility. These protocols may include Wi-Fi®, Bluetooth®, powerline communication (PLC), Zigbee®, Z-Wave, and/or other communications protocols.

The smart energy controller 120 may support ad-hoc discovery of energy-related devices, so as to simplify expansion of the local electrical system 100. For example, the smart energy controller 120 may periodically (or upon user instruction) send out a request to discover unconnected smart energy devices. Connectable devices may include those compatible with the Energy Services Interface (ESI), Programmable Communicating Thermostats (PCT), load devices (e.g., pool pumps, water heaters, other home appliances), plug-in vehicles, and inverters. The present embodiments may encompass a structured set of parameters or data to be provided as a part of the ad-hoc discovery process, such as a load device's maximum power or current draw, a battery's electrical capacity, or a power generation device's maximum power generation capability, or other parameters that will facilitate the overall control of the local electrical system 100.

In some embodiments, the smart energy controller 120 communicates with other devices within the local electrical system 100 using the Smart Energy Profile 2.0 (SEP2.0), also known as IEEE P2030.5. This communications standard provides an application layer specifically designed to support communications between various smart energy devices within a local area network. It is further oriented towards maximal support between the electric utility providers and their consumers, through end devices within the consumers' homes. Furthermore, the SEP2.0 standard functions independent of the media access control (MAC) and physical layers (PHY) of end devices, thereby promoting increased compatibility.

In some embodiments, only a subset of the devices may be present. This may be the case when certain devices such as the micro CHP unit 150 are either not present or simply not configured to communicate with the smart energy controller 120. Furthermore, the smart energy controller 120 need not be an independent device connected to the connectivity hub 122. In some embodiments, the smart energy controller 120 may be embedded in the connectivity hub 122. In some other embodiments, the smart energy controller 120 may be embedded in one of the loads or other devices, such as the smart thermostat 132. The smart energy controller 120 and its associated functionality may also be distributed over multiple devices or have distributed capabilities such as those provided through cloud computing facilities.

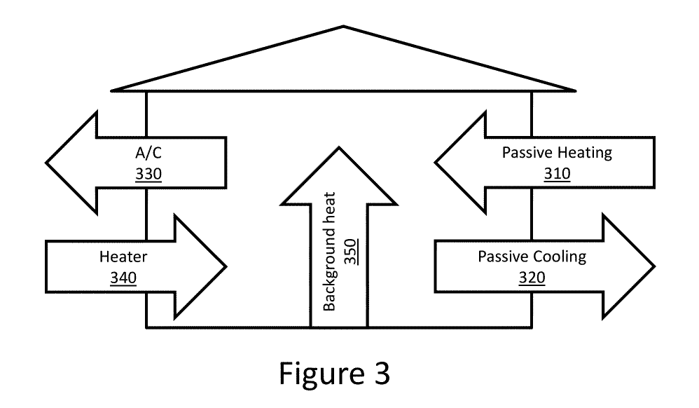

FIG. 3 shows a thermal model of a home with various sources affecting the temperature inside the home. As discussed above, the outside temperature may affect the temperature within the home and accordingly may affect the energy demanded for climate control within the home (e.g., through an HVAC or micro CHP unit). This is because the interface between the home and the outside world allows for heat to leak into or escape from the home. When the internal temperature (e.g., temperature inside the home) is below the outside temperature, the internal temperature increases through passive heating to restore thermal equilibrium, which is represented by the arrow 310. Similarly, when the internal temperature is above the outside temperature, the internal temperature decreases through passive cooling to restore thermal equilibrium, which is represented by the arrow 320. In a sense, the home may be considered a thermal capacitor having a limited but deterministic capability to retain heat. This relationship may be represented by the following thermodynamic equation:

$$C \frac{d x ( t )}{d t} = H ( {T}_{a} ( t ) - x ( t ) ) + Q ( t ) . \qquad Equation ( 1 )$$

In this equation, C represents the thermal capacitance of the home, in kJ/K; x(t) represents the internal temperature in K; Tₐ(t) represents the ambient outside temperature in K; H represents the conductance in kW/K; and Q(t) represents the total heat flux in kW. The total heat flux Q(t) is the sum of heat flux associated with each source. The dominant source may be the heat flux from the HVAC unit when it is activated to cool or heat a home. This is represented in FIG. 3 by the arrows 330 and 340, respectively. Other sources include passive heat loss 320 or gain 310 due to the outside environment. Another significant factor of heat flux is background heat due to appliances, human bodies, lighting, and other heat sources within the home, all of which are represented by the arrow 350.

Equation (1) above demonstrates that, in the absence of a net heat flux, Q(t), the internal temperature will decay asymptotically towards the ambient outside temperature. However, a differential between the indoor and outdoor temperature may be maintained if Q(t) is non-zero, and this can be achieved through the use of an HVAC unit, a micro CHP unit, and other controllable or uncontrollable heating or cooling sources.

Simple thermostats use a system of set points to roughly maintain a temperature. In these systems, when a user sets an indoor temperature to a set point (e.g., 75° F.), the system periodically measures the indoor temperature to determine variation from the set point. On a cold day, if the indoor temperature falls below a pre-determined threshold of deviation from the set point (e.g., 73° F.), the systems begins heating until the indoor temperature reaches a second pre-determined threshold of deviation from the set point (e.g., 77° F.), which is when the heating stops. The indoor temperature slowly falls back to the first pre-determined threshold (e.g., 73° F.), and the process repeats. With this simple system, no temperature models are required, and the thermostat merely reacts to the pre-determined thresholds of deviation from the set points.

The set point system can be greatly improved upon by predicting the home's reaction to a given heating control action (e.g., turning on a heater associated with an HVAC unit), assuming an accurate thermal model of the home is established. An accurate model requires characterization of a few basic parameters, such as the home's thermal capacitance and conductance. Predictive control further requires that the outside temperature be known, and ideally for some time period extending into the future. The previously-described weather forecast data received from external servers may thus play a role in optimizing the heating scheme.

Differential equations, such as that of Equation (1) above, may be somewhat inconvenient to model on a digital system. The smart energy controller may utilize a microcontroller or processor, thereby making it part of a digital system. Accordingly, a discretized version of Equation (1) may be used. For example, Equation (1) may be discretized using a zero-order hold with a sample time of 5 minutes. In other words, the temperature may be sampled every 5 minutes and a simulation may be performed as a series of discrete steps to predict future temperature values with a temporal precision of 5 minutes. In some embodiments, the sample time may be increased or decreased, depending on the desired level of temporal precision as well as the available processing power and data. The discretized equation may be represented as follows:

x(t+1)−x(t)=a(Tₐ(t)−x(t))+b Equation (2).

In this equation, x(t) still represents the temperature in K, though now at a discrete instant of time; x(t+1) represents the temperature in K at the next instant in time; and Tₐ(t) represents the ambient outside temperature in K. The thermal capacitance and conductance are collapsed into a single variable, “a,” which may be stored in a lookup table. The variable “a” may be dependent on a large variety of factors such as the material properties of the house, the humidity inside and outside, the level of cloud cover, etc. Accordingly, the lookup table may store these conditions alongside values of “a” in the lookup table. The variable “b” represents the discretized heat flux. As previously mentioned, it may be dominated by an active heating element, though an additional correction factor may be included to represent other sources of heat, such as appliance usage and home occupancy. When the heating element is active, “b” may be represented by a value b_{heating}, when the cooling element is active, “b” may be represented by a value b_{cooling}, and when neither is active, “b” may be represented by a value b_{off}. These values for “b” may also be stored in a lookup table.

The values of “b” may be determined based on temperature observations (e.g., internal and external temperature) and the operational states of the heating and cooling elements. Values for b_{heating} may be measured and stored during times when a heating element is active. Similarly, values for b_{cooling} may be measured and stored during times when a cooling element is active. Finally, values for b_{off} may be measured and stored during times when neither the heating element nor the cooling element is active.

When multiple configurations of heating and/or cooling are available, additional types of “b” may require characterization. For example, when both a micro CHP unit and a HVAC unit provide heat to a home, “b” may be characterized for scenarios where only the heater of the HVAC unit is active, where only the CHP unit is active, and where both the heater and the CHP unit are active.

The values of “a” and “b” may also change based on other contextual information that may or may not be directly observable. For example, the values may vary depending on the number of people inside the home, whether or not shades are drawn, and whether certain appliances are running. If a type of contextual information is observable, the corresponding operational state may be reported to the smart energy controller and/or stored within the lookup tables.

Certain changes to the home, such as the addition of new appliances, may affect the values of “a” and “b” over time. Accordingly, the smart energy controller may periodically or continually observe and tune the values of “a” and “b” to maintain an accurate thermal model of the home. In this way, even some factors that may not be directly observable may be factored into the home's thermal model.

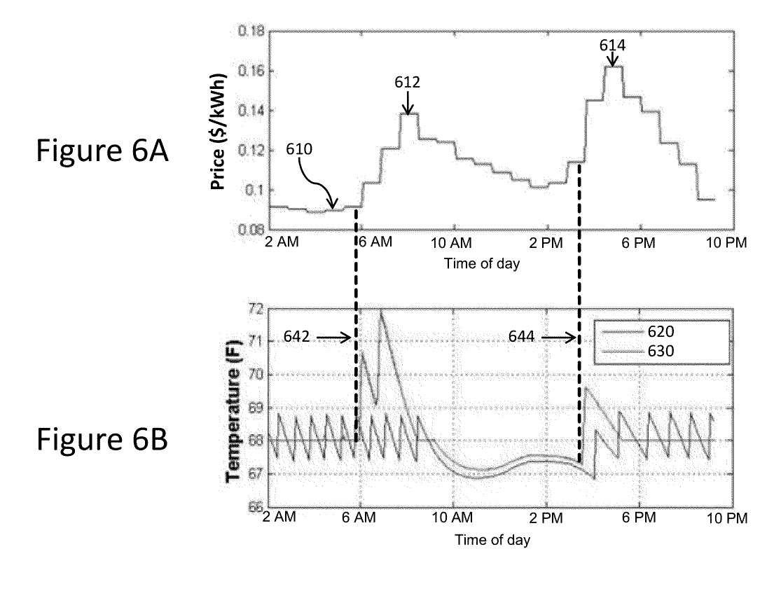

In comparison to Equation (1), Equation (2) is relatively easy to compute by a microcontroller or processor. By using accurate values for “a” and “b” the smart energy controller can effectively predict the results of performing each control action. For example, the smart energy controller may determine how much time (and energy) is required to achieve a certain temperature, given internal and external conditions. With a thermal model of the home in place, heating and cooling control can thus be further optimized, which will be further described below with regard to FIGS. 6A-6B

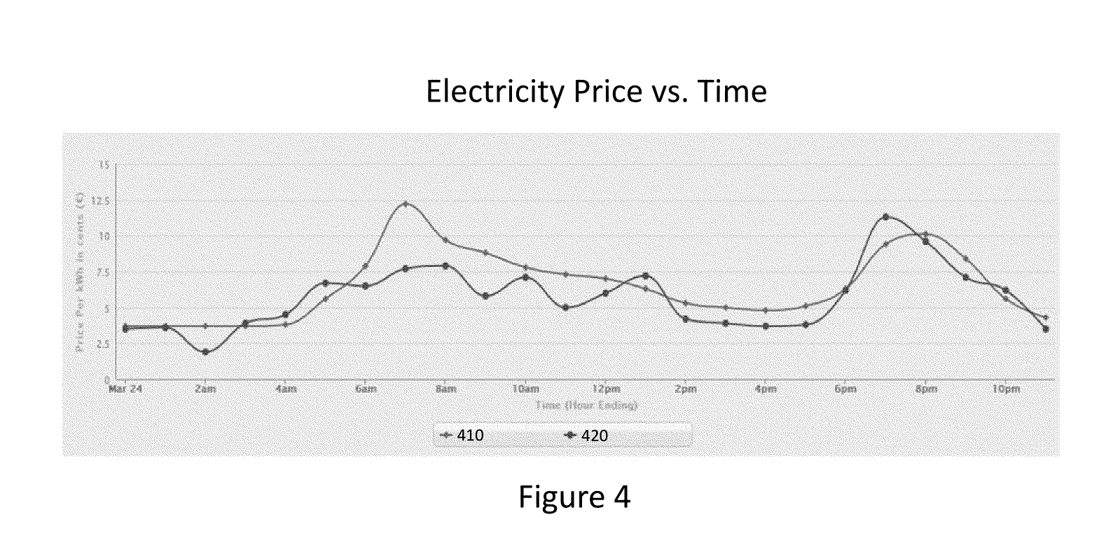

FIG. 4 shows a graph illustrating energy prices over the course of a day. The time of day is measured on the horizontal axis, and the price, in cents/kWh, is measured on the vertical axis. Dataset 410 represents projected hourly prices, which may be available to consumers 24-hours in advance or at some other lead-time relative to actual. Sometimes known as “day-ahead prices,” these projected prices allow energy consumers (e.g., users) to know the-time varying prices in advance, which would theoretically allow them to better plan their energy consumption. The projected prices are generally fixed for a given time interval, such as 15 minutes or an hour. In some scenarios, the day-ahead prices may be binding, and in other scenarios, the day-ahead prices may simply be predictions that do not reflect the exact cost.

Dataset 420 represents real-time pricing data during the same time period. These prices are also generally fixed for a given time interval. This type of data may better reflect the true cost of energy, but as these prices are given in real time or on short notice before taking effect (e.g., on an hourly basis), dataset 420 may be more useful for coordinating events that occur on a smaller time scale. For example, real time dataset 420 is useful for determining whether or not to perform discretionary, energy-intensive tasks.

In practice, manually changing a home's energy consumption based on day-ahead prices or real-time pricing is too tedious for the average energy consumer, and the consumer-side benefits are not fully realized. In accordance with this disclosure, either or both datasets 410 and 420 may be received at the smart energy controller and utilized when determining a cost-optimal plan. By automatically coordinating a home's local electrical system 100 to react to this information, the pricing data is made transparent to the end user, so that they need not unnecessarily spend time performing the cost optimizations.

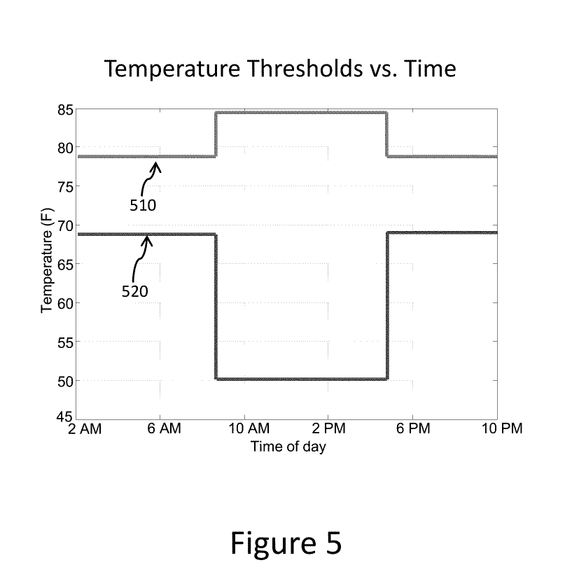

FIG. 5 shows a graph illustrating exemplary temperature thresholds in a home. The time of day is measured on the horizontal axis, and temperature, in degrees Fahrenheit, is measured on the vertical axis. The upper temperature threshold 510 represents the highest allowable temperature for the home as a function of time, and the lower temperature threshold 520 represents the lowest allowable temperature. The thresholds 510 and 520 may vary as a function of time to account of the user schedule and preferences. As shown in FIG. 5, the thresholds may be relaxed during the middle of the day, especially during a weekday when the user is most likely out of the home. During this period, the upper temperature threshold 510 may reach a level above what would typically be comfortable for a human but below a level that might risk damage to items within the home. The lower temperature threshold 520 may similarly be reduced during this period of inoccupancy. The thresholds 510 and 520 may be manually programmed by the user, “learned” by the smart energy controller by recognizing patterns of user input, or determined through other techniques.

The thresholds 510 and 520 provide allowable temperature ranges, and having such ranges generally reduces the amount of energy (and cost) associated with controlling the home's climate over the period of the day. In this context, thresholds are not necessarily set points indicating temperatures that the home is targeted to reach. Instead, they represent the range of allowable temperatures and provide flexibility for the smart energy controller when setting temperatures in accordance with a cost-optimal strategy.

FIGS. 6A-6B show graphs illustrating an exemplary preheating technique based, in part, on pricing data, in accordance with the disclosed principles. FIG. 6A shows a graph illustrating projected pricing data 610 as a function of time. The time of day is measured on the horizontal axis, and the price, in dollars/kWh, is measured on the vertical axis. The projected pricing data 610 indicates that the price of energy may, for example, have a first projected pricing peak 612 that occurs between 6 AM and LOAM, and a second projected pricing peak 614 that occurs between 2 PM and 6 PM. In accordance with the disclosed principles, the smart energy controller may use the projected pricing data 610 to decrease overall cost, for example, by decreasing energy consumption during time periods near the projected pricing peaks 612 and 614.

FIG. 6B shows a graph illustrating temperature within a home using conventional techniques compared to temperature within a home using a smart energy controller in accordance with the disclosed principles. The time of day is measured on the horizontal axis, and temperature, in degrees Fahrenheit, is measured on the vertical axis.

The temperature within a home using conventional techniques is represented by dataset 620. In this example, from 2 AM to 9 AM, a conventional controller may use a set point (e.g., 68° F.) during certain periods of the day when the user is generally home, in accordance with a programmed schedule (e.g., until 9 AM, and again from 4 AM onwards). During this time, projected pricing data 610 is not taken into account. As a result, the heater is equally utilized between periods of relatively low cost and periods of relatively high energy cost, and no savings are achieved.

The temperature within a home using a smart energy controller in accordance with the disclosed principles is represented by dataset 630. Here, the pricing data 610 is analyzed by the smart energy controller so that less energy is consumed during high pricing periods in favor of energy consumption during low pricing periods. This is achieved, in part, by creating a thermal model based on the home's thermal properties. Once the thermal model is created, the homes thermal capacitance may be predictably utilized to store energy (e.g., as heat) in anticipation of the high pricing periods.

The smart energy controller further utilizes temperature thresholds, as shown in FIG. 5, which provide flexibility in control. The smart energy controller determines a cost-optimal time to begin heating the home, taking into account the thermal model as well as the constraints set forth by the temperature thresholds. As shown in FIG. 6B, the home is preheated starting at time 642, which is before the projected pricing peak 612 shown in FIG. 6A. Similarly, the home is preheated starting at time 644, which is before the projected pricing peak 614 shown in FIG. 6A. This allows less energy to be consumed during the peak pricing periods, and more energy to be consumed when energy is relatively less expensive. And, by staying within temperature thresholds, this strategy further promotes a level of comfort for the user.

The smart energy controller may be capable of providing a higher granularity of control, through the use of “tighter” control loops. This is shown by the dataset 630 having smaller oscillations than dataset 620 during steady state periods (e.g., between 2 AM and 6 AM). However, tighter control loops need not be implemented to achieve at least some of the benefits of the disclosure.

The heat may be supplied by a heater associated with an HVAC unit, a micro CHP unit, other devices for providing heat, or any combination thereof. When more than one device is selected for heating, the smart energy controller may adaptively determine how much of the required heat should be supplied from each heating device. In other words, the relative energy consumed for heating at each device may be varied, which allows additionally flexibility when determining a cost-optimal solution. For example, the smart energy controller may determine that it would be advantageous to supplement grid power during a time when heating is required. It may then be beneficial to run a micro CHP unit at high or full capacity to generate supplemental power for the home, while also generating the useful heat. If the smart energy controller determines that the grid will provide sufficient power at a cost-effective rate, the micro CHP unit may run at a lower capacity or be deactivated altogether.

Energy may also be required to cool a home on a hot day. Though not shown in FIGS. 6A-6B, a similar process may be implemented to precool a home. In this scenario, the energy controller may determine cost-optimal times to run cooling devices within the home, which again may be before (and after) projected pricing peaks.

The system may also be adapted to apply to other pricing schemes that may be offered by the utility provider. One such scheme is a time-of-use pricing scheme, wherein the pricing is fixed depending on the time of the day and the day of the week. While the price here still varies as a function of time, the variance is known well ahead of time as it may be set in a contract as a pricing schedule. Here, the smart energy controller may not need to connect to an external pricing data server. Instead, the pricing schedule may be stored locally and updated when the terms of the contract or the established prices change. When determining the energy pricing for a specific time interval, the smart energy controller may simply search the locally stored pricing schedule.

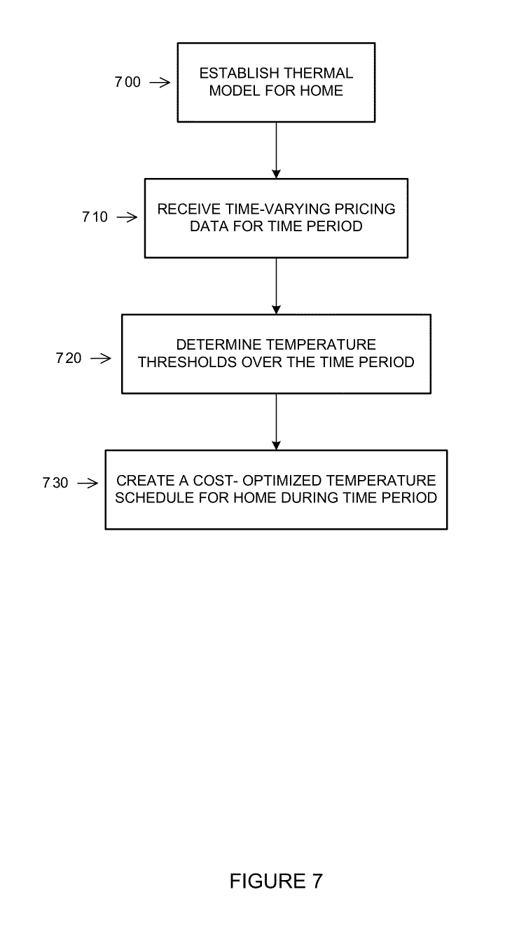

FIG. 7 shows a flowchart diagram illustrating an exemplary process for heating and cooling a home. At the action 700, a thermal model is created for the home. This model may reflect the thermal properties of the home which may include how quickly heat may leak into and out of the home. Thermal parameters associated with the thermal model may be stored in a lookup table (e.g., in a look-up table in the configuration database 240) having fields for internal factors (e.g., thermal capacitance, operational state of heating and cooling elements, and internal humidity) and external factors (e.g., weather and external humidity). The model may vary over time. This thermal model may be created in accordance with the description of FIG. 3.

At the action 710, time-varying pricing data is received for a time period during which time cost-optimization is performed. The time-varying pricing data may be received from an external pricing data server, as described in FIG. 2. In some embodiments, such as those associated with time-of-use pricing, the time-varying pricing data may be stored locally.

At the action 720, temperature thresholds are established over the time period. The thresholds may vary as a function of time. In some embodiments, the thresholds may be manually set by the user, for example, by programming a temperature schedule. In other embodiments, the thresholds may be automatically determined by the smart energy controller, based on factors such as the user schedule, previous temperature decisions made by the user, and externally-received data. The order of the actions 700, 710, and 720 may be varied with respect to one another.

At the action 730, the thermal model, time-varying pricing data, and temperature thresholds may be analyzed to create a cost-optimized temperature schedule for the home during the time period. Additional factors may also be considered when determining the temperature schedule. The smart energy controller may then provide control to the devices within the home to implement the temperature schedule. The temperature schedule may involve preheating or precooling the home, as shown in FIGS. 6A-6B and the accompanying descriptions.

In some embodiments, the temperature schedule may be altered after it is created. This provides flexibility for the smart energy controller to account for disturbances that were not predicted or projected at the time when the schedule was initially created. For example, in disclosed embodiments, the user comfort level and/or further savings can be even further assured by using the above-described principles while also using the GPS location techniques to determine, for example, if a user has left work earlier or even later than scheduled. Thus, if the user is working late and has not left for home at the normally expected time, the smart energy controller 120 can further delay the heating or cooling activity, resulting in even greater cost savings.

FIG. 8 shows a block diagram illustrating a system for charging an electric vehicle in accordance with the principles described herein. The system optimizes the charging of the electric vehicle 172 to further reduce cost. FIG. 8 contains certain entities that may be similar or identical to those present in FIGS. 1-2. These entities are labeled with the same reference numerals and will not be described again.

The electric vehicle 172 may include a battery 810 that may be charged on a cyclical basis by the home's charging platform 170. The smart energy controller 120 may coordinate the charging of the battery 810 with pricing data received from the pricing data server 220. In general, the battery 810 may be charged when the marginal cost of receiving electricity from the grid 112 is relatively low. The optimization may additionally or alternatively involve selecting periods when local energy sources 820 (e.g., a micro CHP unit or a solar panel and inverter) are generating energy for the home. This may reduce the home's peak demand from the grid 112 as well as improve overall energy efficiency by reducing energy transmission losses. The battery 810 may further be charged during periods when other loads are consuming relatively little energy. Further, similar principles may apply to the battery management system 162 and its associated battery 160 (e.g., stationary battery 160).

As previously discussed, the smart energy controller 120 may calculate the predicted schedule and mileage requirements for the electric vehicle. With this information, the smart energy controller 120 may determine an optimal charging schedule for charging the electric vehicle 172, when the electric vehicle 172 is parked at the home. This would allow the electric vehicle 172 reaches a sufficient level of charge for the next cycle (e.g., day trip), while energy costs are controlled. In some scenarios, this may involve restricting the charging platform 170 from fully charging the electric vehicle 172, and instead only providing enough charge to allow the electric vehicle 172 to reach the predicted mileage target with some overhead. When determining the charging schedule, the smart energy controller 120 may further consider factors such as whether the user has another source for charging the electric vehicle 172 (e.g., another charging platform near or at the user's workplace).

The following is an exemplary scenario demonstrating the coordination of local energy sources 820 (e.g., a micro CHP unit) with local energy reserves (e.g., the stationary battery 160 and the electric vehicle's battery 810). In this scenario, a smart energy controller 120 may control both a HVAC unit and a CHP unit. During a home heating decision, the smart energy controller 120 may compare the expected cost of heating with the HVAC unit with the expected cost of heating with the micro CHP unit and with the expected cost of heating with both the HVAC unit and the micro CHP unit. If the micro CHP unit is selected for heating, the smart energy controller 120 may determine whether or not a battery may be cost-effectively charged during the time when the micro CHP unit is active. If it is determined that a battery may be charged, the smart energy controller 120 may further calculate the relative cost-effectiveness of charging the stationary battery 160, the electric vehicle's battery 810, and both batteries 160 and 810 simultaneously. This decision may be made according to the instantaneous amount of charge in each battery, the predicted usage of each battery (e.g., when and how far the user will be driving the electric vehicle 172), and/or other factors.

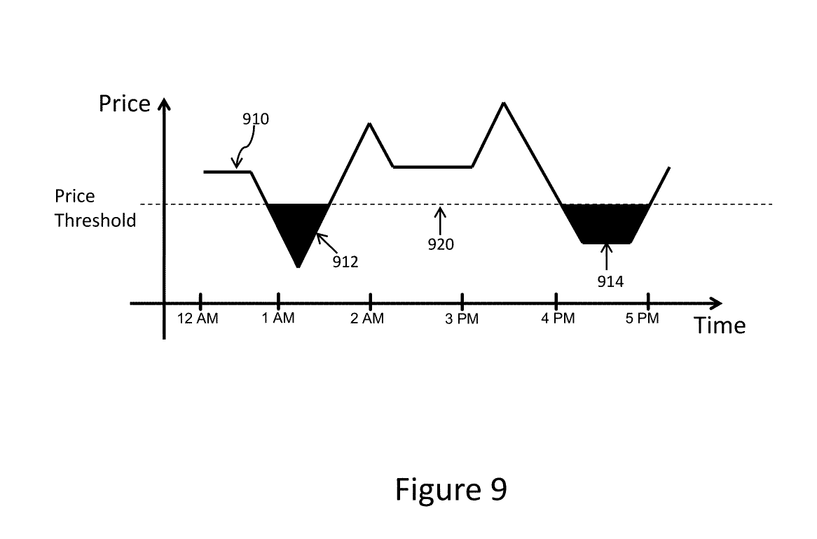

FIG. 9 shows a graph illustrating a strategy for charging an electric vehicle's battery using a water-filling algorithm. The time of day is measured on the horizontal axis, and the price is measured on the vertical axis. Dataset 910 represents energy pricing data that is received from the pricing data server by the smart energy controller. The dataset 910 may extend over the period of time that is available to charge the electric vehicle.

The smart energy controller may determine a price threshold 920, which may be based, at least in part, on the data from the pricing data server or input from a user. The smart energy controller may determine a period or periods of time where the price of energy is projected or determined to be below the price threshold 920. These time periods may be selected for charging the electric vehicle. As shown in the figure, a first period 912 and a second period 914 both allow for the electric vehicle to be charged when the energy price is below the price threshold 920.

The smart energy controller may charge the electric vehicle at a variable rate that is dependent on the price of energy. For example, the charging rate (e.g., the rate at which energy is delivered to the electric vehicle) may be highest during periods when the energy price is lowest. This technique is especially valuable in scenarios where future pricing data is not available or reliable. It allows the smart energy controller to apply a finer granularity of control than simply charging or not charging the electric vehicle. In some embodiments, the charging rate is proportional to the difference between the instantaneous energy price and the price threshold. If this technique is applied, the area of the darkened regions between the price threshold 920 and the actual (or projected) price of energy reflected by dataset 910 (e.g., the darkened regions associated with the first period 912 and the second period 914) may represent the amount of charge received by the electric vehicle.

If the smart energy controller determines that the electric vehicle would not receive sufficient charge over the time period available for charging, it may incrementally increase the price threshold 920. In some embodiments, the user may have the option of being alerted when such increases occur, and the user may be required to approve these increases to the price threshold 920. The user may also have the option of setting a price threshold that specifies a maximum price that the user is willing to pay for electricity. The user may be required to approve any action that sets the price threshold 920 above the user-set price threshold. The user-set price threshold may be set, e.g., as a cost per unit of distance or as a cost per unit of energy. If it is set in different units from those used for the price threshold 920, the smart energy controller may perform a conversion using, e.g., an expected efficiency of the electric vehicle.

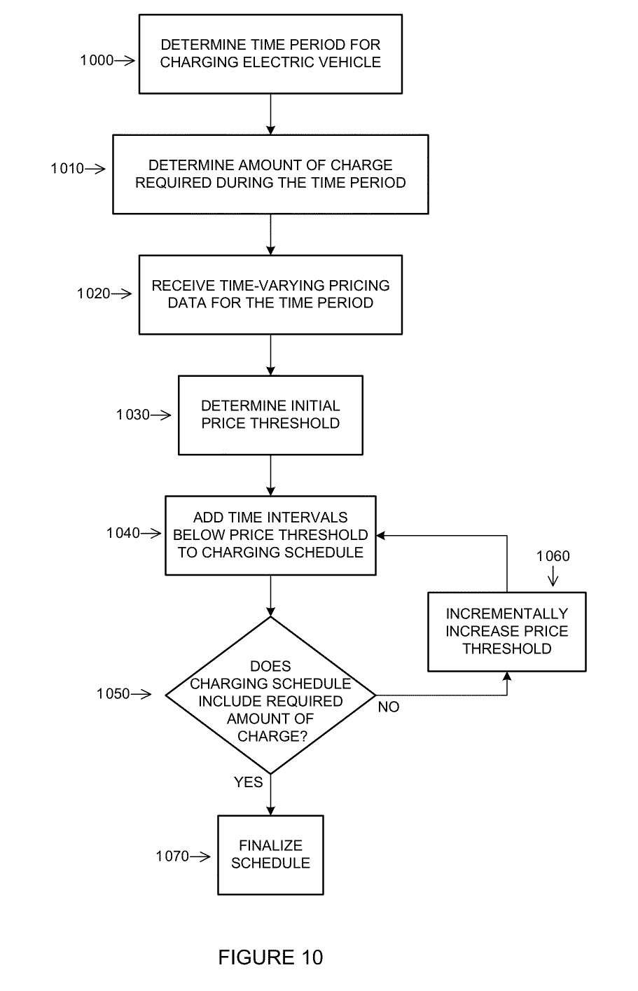

FIG. 10 shows a flowchart diagram illustrating an exemplary process for charging an electric vehicle.

At the action 1000, the smart energy controller determines a time period for charging the electric vehicle, which may be dependent on the user schedule. The user schedule may be manually input by the user, or it may be automatically determined by the smart energy controller. The smart energy controller may utilize GPS data to determine the user schedule, or it may receive the user schedule directly from an external device as is discussed above in the description of FIG. 1.

At the action 1010, the smart energy controller determines an amount of charge required during the time period. This information may also be determined based on the user schedule and through the usage of GPS data. The user may manually change this value if a deviation is expected. In some embodiments, the smart energy controller fully charges the electric vehicle every cycle. In these embodiments, the amount of charge required is simply the difference between the amount of charge remaining in the electric vehicle at the beginning of the time period and the charge capacity of the electric vehicle.

At the action 1020, the smart energy controller receives time-varying pricing data for the time period. The time-varying pricing data may be received from an external pricing data server. In some embodiments, such as those associated with time-of-use pricing, the time-varying pricing data may be stored locally.

At the action 1030, the smart energy controller determines an initial energy price threshold, which may be the minimum projected price during the time period available for charging the electric vehicle. The relative order of actions 1020 and 1030 may vary.

At the action 1040, the smart energy controller creates a charging schedule if one does not yet exist and adds time intervals where the energy price is below the price threshold to the charging schedule. These time intervals are selected based on the time-varying pricing data received at the action 1020.

At the action 1050, the smart energy controller determines whether or not the charging schedule provides the required amount of charge to the electric vehicle, as was determined in the action 1010. If it is determined that the electric vehicle will be sufficiently charged, the smart energy controller proceeds to the action 1070. If not, the energy controller proceeds to the action 1060.

At the action 1070, the smart energy controller incrementally increases the price threshold. The energy controller then returns to the action 1040. The process of actions 1040, 1050, and 1060 repeats until the smart energy controller determines that the charging schedule provides the required level of charge.

At the action 1070, the schedule is finalized. If the smart energy controller determines that the price threshold is above a user-set price threshold, as described above, the user may be asked to confirm the increase, or the user may simply be notified of the increase.

Even after the action 1070, the charging schedule may be recomputed periodically, continually, or based on certain events, such as unexpected price changes and/or signals from utility providers over the grid (e.g., demand-response).

While FIGS. 8-10 demonstrate the charging of an electric vehicle's battery, the principles may be adapted to charging other types of energy reserves or providing power to loads. Time-shiftable electrical loads, such as pool pumps, may be controlled with some of the same principles described above. Such loads must also be activated on a cyclical basis, and the smart energy controller may have some flexibility in timing their energy consumption.

In the case of a pool pump, the smart energy controller may have flexibility to control when the pool pump is active each cycle. Unlike the charging of a battery, however, the pool pump requires energy for a period of fixed duration each cycle. As the start time of this period can be varied, the smart energy controller has one degree of freedom. The smart energy controller may utilize time-varying pricing data to determine a contiguous block of time that has the lowest total cost of energy, which may similarly involve avoiding peak prices. The schedule may vary each cycle based, at least in part, on the pricing data. This results in greater savings than any schedule that uses fixed timings for each cycle, even if the fixed timings are during non-peak pricing periods.

While various embodiments in accordance with the disclosed principles have been described above, it should be understood that they have been presented by way of example only, and are not limiting. Thus, the breadth and scope of the disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

While the term “home” is often used within this disclosure, this is not intended to be limiting. The disclosed principles are equally applicable to offices, retail establishments, and any other types of buildings or facilities which have networked energy-related devices. Accordingly, where the term “home” is used, the meaning should generally be construed to include building or facility. Further, the disclosed principles may be applied to a plurality of buildings or facilities sharing a centralized controller for energy management.

Various terms used in the present disclosure have special meanings within the present technical field. Whether a particular term should be construed as such a “term of art” depends on the context in which that term is used. “Connected to,” “in communication with,” “associated with,” or other similar terms should generally be construed broadly to include situations both where communications and connections are direct between referenced elements or through one or more intermediaries between the referenced elements. These and other terms are to be construed in light of the context in which they are used in the present disclosure and as one of ordinary skill in the art would understand those terms in the disclosed context. The above definitions are not exclusive of other meanings that might be imparted to those terms based on the disclosed context.

The smart energy controller may be networked with the various devices and entities within the system using any networking technique known in the art. The smart energy controller may be part of a local area network, a wide area network, or even a metropolitan area network. Various protocols may be used to communicate between devices and entities within the home's network and outside of the home's network. The protocols may include Wi-Fi, Bluetooth®, powerline communication (PLC), Zigbee®, Z-Wave, cellular technology, and/or any combination thereof.

GPS location systems are described for determining a consumer's location, but other techniques may be alternatively or additionally used. For example, location information may be determined though triangulation based on the cellular networks or any other technique known in the art.

The smart energy controller is described chiefly as a local processor in a local environment, but that computing functionality could be provided remotely through thin-client communications or other communications with in-home devices and/or through distributed computing capabilities. The smart energy controller may be a standalone device or it may be embedded into one or more in-home devices such as the connectivity hub and/or the smart thermostat.

Further, while some aspects of the disclosure are discussed in the context of electricity, the principles may be applicable to other forms of energy such as natural gas, useful heat, or fluid pressure.

Words of comparison, measurement, and timing such as “at the time,” “equivalent,” “during,” “complete,” “identical,” and the like should be understood to mean “substantially at the time,” “substantially equivalent,” “substantially during,” “substantially complete,” “substantially identical,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the subject matter set forth in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any subject matter in this disclosure. Neither is the “Summary” to be considered as a characterization of the subject matter set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method for controlling a local energy system of devices, the devices comprising a generator and a shiftable load, the method comprising:
establishing respective electronic communications between an energy controller and the generator as well as between the energy controller and the shiftable load;
receiving, at the energy controller, first operational state information from the generator;
receiving, at the energy controller, second operational state information from the shiftable load;
determining, by the energy controller, a time-variable marginal cost of energy; and
controlling, by the energy controller, the shiftable load based, at least in part, on the first operational state information and the time-variable marginal cost of energy, to optimize, at least partially, operational cost of the total energy consumed by the local energy system.

2. The method of claim 1, wherein the determining of the time-variable marginal cost of energy comprises receiving, by the energy controller, energy pricing data from an external server.

3. The method of claim 1, wherein the determining of the time-variable marginal cost of energy comprises searching, by the energy controller, a pricing schedule associated with a time-of-use pricing scheme.

4. The method of claim 1, further comprising:
receiving, by the energy controller, weather forecast data from an external server.

5. The method of claim 4, wherein the controlling of the shiftable load is based, at least in part, on the weather forecast data.

6. The method of claim 1, wherein the shiftable load comprises an electric vehicle that is connected to the local energy system.

7. The method of claim 6, further comprising:
controlling, by the energy controller, an operational state of the electric vehicle to promote overlap with a generation period when the generator provides energy.

8. The method of claim 6, further comprising:
determining, by the energy controller, the time-variable marginal cost of energy over a time period extending to a future instant in time;
determining, by the energy controller, a net charge required by the electric vehicle during the time period; and
determining, by the energy controller, a charging schedule for delivering the net charge to the electric vehicle over the time period using a water-filling algorithm, such that potential time periods with comparatively lower marginal costs are selected as charging periods for the charging schedule.

9. The method of claim 8, wherein the net charge required by the electric vehicle is determined, at least in part, by a user schedule.

10. The method of claim 9, wherein the user schedule is determined, at least in part, by location information.

11. The method of claim 6, wherein the controlling of the shiftable load comprises controlling an adjustable charging rate of the electric vehicle for a time period.

12. The method of claim 11 wherein the adjustable charging rate of the electric vehicle for the time period is based, at least in part, on a difference between the time-variable marginal cost of energy during the time period and a price threshold.

13. The method of claim 1, wherein the shiftable load comprises a heating, ventilation, and air conditioning (HVAC) unit.

14. The method of claim 13, further comprising:
controlling, by the energy controller, the HVAC unit based, at least in part, on a user schedule,
wherein the user schedule is determined, at least in part, by location information.

15. The method of claim 1, wherein the shiftable load is activated at a start time for a predetermined duration.

16. The method of claim 15, wherein the controlling of the shiftable load comprises controlling the start time based, at least in part, on a calculated cost of energy associated the shiftable load being activated during the start time for the predetermined duration.

17. The method of claim 1, wherein a rate of energy delivered to the first shiftable load is varied based, at least in part, on the time-variable marginal cost of energy.

18. The method of claim 17, wherein the rate of energy is proportional to a difference between the time-variable marginal cost of energy and a price threshold.

19. The method of claim 1, wherein the local energy system further comprises an energy storage device, and the method further comprises:
receiving, at the energy controller, third operational state information from the energy storage device; and
controlling, by the energy controller, the energy storage device based, at least in part, on the first operational state information and the time-variable marginal cost of energy, to optimize, at least partially, the operational cost of the total energy consumed by the local energy system.

20. The method of claim 1, wherein the shiftable load comprises a first shiftable load and a second shiftable load, and wherein the method further comprises:
receiving, at the energy controller, fourth operational state information from the second shiftable load; and
controlling, by the energy controller, an operational state of the second shiftable load to limit overlap with a consumption period of the first shiftable load and to promote overlap with a generation period when the generator provides energy.

21. A method for controlling a local energy system of devices, the devices comprising a generator and an electric vehicle, the method comprising:
establishing respective electronic communications between an energy controller and the generator as well as between the energy controller and the electric vehicle;
receiving, at the energy controller, first operational state information from the generator;
receiving, at the energy controller, second operational state information from the electric vehicle;
determining, by the energy controller, a time-variable marginal cost of energy; and
controlling, by the energy controller, charging of the electric vehicle based, at least in part, on the first operational state information and the time-variable marginal cost of energy, to optimize, at least partially, operational cost of the total energy consumed by the local energy system.

22. The method of claim 21, wherein the controlling of the charging of the electric vehicle is adjusted to promote overlap with a generation period when the generator provides energy.

23. The method of claim 21, further comprising:
determining, by the energy controller, the time-variable marginal cost of energy over a time period extending to a future instant in time;
determining, by the energy controller, a net charge required by the electric vehicle during the time period; and
determining, by the energy controller, a charging schedule for delivering the net charge to the electric vehicle over the time period using a water-filling algorithm, such that potential time periods with comparatively lower marginal costs are selected as charging periods for the charging schedule.

24. The method of claim 23, wherein the net charge required by the electric vehicle is determined, at least in part, by a user schedule.

25. The method of claim 24, wherein the user schedule is determined, at least in part, by location information.

26. The method of claim 25, wherein the charging of the electric vehicle comprises controlling an adjustable charging rate of the electric vehicle for a time period.

27. A method for controlling a local energy system of devices, the devices comprising a generator and a heating, ventilation, and air conditioning (HVAC) unit, the method comprising:
establishing respective electronic communications between an energy controller and the generator as well as between the energy controller and the HVAC unit;
receiving, at the energy controller, first operational state information from the generator;
receiving, at the energy controller, second operational state information from the HVAC unit;
determining, by the energy controller, a time-variable marginal cost of energy; and
controlling, by the energy controller, the HVAC unit based, at least in part, on the first operational state information and the time-variable marginal cost of energy, to optimize, at least partially, operational cost of the total energy consumed by the local energy system.

28. The method of claim 27, further comprising:
controlling, by the energy controller, the HVAC unit based, at least in part, on a user schedule.

29. The method of claim 27, further comprising:
determining, by the energy controller, upper and lower temperature thresholds over a time period extending to a future instant in time;
determining, by the energy controller, the time-variable marginal cost of energy over the time period; and
determining, by the energy controller, a temperature schedule for controlling the HVAC unit to maintain an indoor temperature above the lower temperature threshold and below the upper temperature threshold over the time period, while optimizing, at least partially, the operational cost of the total energy consumed by the local energy system.

30. A method for controlling a local energy system of devices, the devices comprising a generator, a shiftable load, and an energy storage device, the method comprising:
establishing respective electronic communications between an energy controller and the generator, between the energy controller and the shiftable load, and between the energy controller and the energy storage device;
receiving, at the energy controller, first operational state information from the generator;
receiving, at the energy controller, second operational state information from the shiftable load;
receiving, at the energy controller, third operational state information from the energy storage device;
determining, by the energy controller, a time-variable marginal cost of energy; and
controlling, by the energy controller, both the shiftable load and the energy storage device based, at least in part, on the first operational state information and the time-variable marginal cost of energy, to optimize, at least partially, operational cost of the total energy consumed by the local energy system.

31. A method for controlling a local energy system of devices, the devices comprising a generator, a first shiftable load, and a second shiftable load, the method comprising:
establishing respective electronic communications between an energy controller and the generator as well as between the energy controller and both of the first and second shiftable loads;
receiving, at the energy controller, first operational state information from the generator;
receiving, at the energy controller, second operational state information from the first shiftable load;
receiving, at the energy controller, fourth operational state information from the second shiftable load;
determining, by the energy controller, a time-variable marginal cost of energy; and
controlling, by the energy controller, both the first and second shiftable loads based, at least in part, on the first operational state information and the time-variable marginal cost of energy, to optimize, at least partially, operational cost of the total energy consumed by the local energy system.

32. The method of claim 31, wherein the controlling of both the first and second shiftable loads comprises limiting overlap between a first consumption period of the first shiftable load when the first shiftable load consumes energy and a second consumption period of the second shiftable load when the second shiftable load consumes energy.
